(19) United States
(12) Patent Application Publication
(10) Pub. No.: US 2016/0099806 A1
(43) Pub. Date: Apr. 7, 2016

(54) DISTRIBUTING SECRET KEYS FOR MANAGING ACCESS TO ECUS

(71) Applicant: GM Global Technology Operations LLC, Detroit, MI (US)

(72) Inventors: David W. Racklyeft, Troy, MI (US); David M. Nairn, Plymouth, MI (US); Thomas M. Forest, Macomb, MI (US)

(21) Appl. No.: 14/508,355

(22) Filed: Oct. 7, 2014

(51) Int. Cl. H04L 9/08; H04W 12/04; H04L 29/06

(52) U.S. Cl. CPC H04L 9/0819; H04L 63/10; H04L 9/0861; H04L 9/0894; H04W 12/04

(57) ABSTRACT

A system and method of controlling access to electronic control units (ECUs) includes: receiving, at an ECU supplier computer, a supplier encryption key derived from a master encryption key using a supplier identifier that identifies an ECU supplier; issuing an ECU identifier that identifies an ECU and includes the supplier identifier; generating for the ECU an ECU unlock authorization key using the supplier encryption key and the ECU identifier; and storing the ECU unlock authorization key and the ECU identifier in the ECU.

### TECHNICAL FIELD

The present invention relates to electronic control units (ECUs) and, more particularly, to controlling access to ECUs using a cryptographic key system.

### BACKGROUND

Many vehicles and other devices include electronic control units (ECUs) that govern a variety of tasks. The ECUs can be programmed to execute computer-readable instructions and control mechanical and/or electrical devices based on those instructions. For example, a powertrain control module (PCM) can act as a central decision making authority for the powertrain of a vehicle and take the form of an ECU that carries out that purpose. A number of vehicle engine parameters can be controlled by the PCM, such as ignition timing of an internal combustion engine (ICE) or an exhaust gas recirculation (EGR) valve to name a few.

The manufacturers of the vehicles or devices may wish to regulate access to the instructions or other operating aspects of the ECUs. Using the example of the PCM above, a vehicle manufacturer may wish to limit access to the instructions and other features of the PCM to authorized individuals. To do so, a secret cryptographic key can be used to create a unique unlock key for each ECU at the time it is manufactured. The manufacturer of the ECU can then store the unlock keys in a central database. However, such a system can be problematic. Given the volume of ECUs that are manufactured, maintaining a database that includes all of the ECU unlock keys can consume significant amounts of computing space and resources. Creating such a database can be complex and difficult considering that ECUs may not be manufactured by a single manufacturer but instead by a number of different manufacturers. Moreover, if the data included in the database becomes corrupt it would be impossible to gain access to many if not all of the ECUs identified in the database. It would be helpful to control access to ECUs without relying on a central database to identify unlock keys.

### SUMMARY

According to an embodiment of the invention, there is provided a method of controlling access to electronic control units (ECUs). The method includes receiving, at an ECU supplier computer, a supplier encryption key derived from a master encryption key using a supplier identifier that identifies an ECU supplier; issuing an ECU identifier that identifies an ECU and includes the supplier identifier; generating for the ECU an ECU unlock authorization key using the supplier encryption key and the ECU identifier; and storing the ECU unlock authorization key and the ECU identifier in the ECU.

According to another embodiment of the invention, there is provided a method of controlling access to electronic control units (ECUs). The method includes receiving at a central facility having access to a master encryption key an ECU identifier that has been accessed from an ECU; isolating a supplier identifier included in the ECU identifier; re-creating a supplier encryption key from the supplier identifier using the master encryption key; and generating an ECU unlock authorization key using the supplier encryption key and the ECU identifier.

According to yet another embodiment of the invention, there is provided a method of controlling access to electronic control units (ECUs). The method includes generating a master encryption key for creating supplier encryption keys; generating a supplier encryption key using the master encryption key and a supplier identifier; providing the supplier encryption key to an ECU supplier computer; issuing an ECU identifier that uniquely identifies an ECU and includes the supplier identifier; generating for the ECU an ECU unlock authorization key using the supplier encryption key and the ECU identifier; storing the ECU unlock authorization key and the ECU identifier in the ECU; receiving, at a central facility having access to the master encryption key, the ECU identifier that has been accessed from the ECU; isolating the supplier identifier included in the ECU identifier; recreating the supplier encryption key from the supplier identifier using the master encryption key; and generating the ECU unlock authorization key using the supplier encryption key and the ECU identifier.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a block diagram of a flow chart of a method of controlling access to electronic control units (ECUs).

### DETAILED DESCRIPTION OF THE ILLUSTRATED EMBODIMENTS

The system and method described below control access to electronic control units (ECUs) by using a secret master encryption key that generates a unique supplier encryption key for each supplier or manufacturer of ECUs by cryptographically manipulating a supplier identifier that is assigned to each ECU supplier. Each supplier encryption key can be provided to a specific ECU supplier that can encode every ECU it manufactures with an ECU identifier and a unique ECU unlock authorization key. For each ECU manufactured, the ECU supplier can generate an ECU identifier that not only uniquely identifies the ECU but also includes the supplier identifier. The ECU identifier can be processed using the supplier encryption key and a key generation algorithm such that the ECU identifier is cryptographically manipulated to create the ECU unlock authorization key that will be stored in the ECU along with the ECU identifier.

Authorized individuals may want to access a particular ECU after it has been manufactured or installed in a vehicle. To grant such access, the authorized individual can contact a central facility having access to the master encryption key that generated the supplier encryption keys. The ECU identifier of the ECU to be accessed can be provided to the central facility and the supplier identifier can be isolated from the ECU identifier. The central facility can feed the supplier identifier of the ECU to be accessed into a key generation algorithm using the master encryption key to re-create the supplier encryption key for the ECU to be accessed. The ECU identifier can then be entered into a key generation algorithm using the re-created supplier encryption key to generate a copy of the ECU unlock authorization key. Access to the ECU can be gained by using the copy of the ECU unlock authorization key. Rather than maintaining a database that includes each ECU manufactured along with its corresponding key, particular ECU unlock authorization keys can be re-created on demand using a multi-tiered encryption key system involving a master encryption key that can be called on to re-create a unique supplier encryption key. The supplier encryption key then can re-create a particular ECU unlock authorization key.

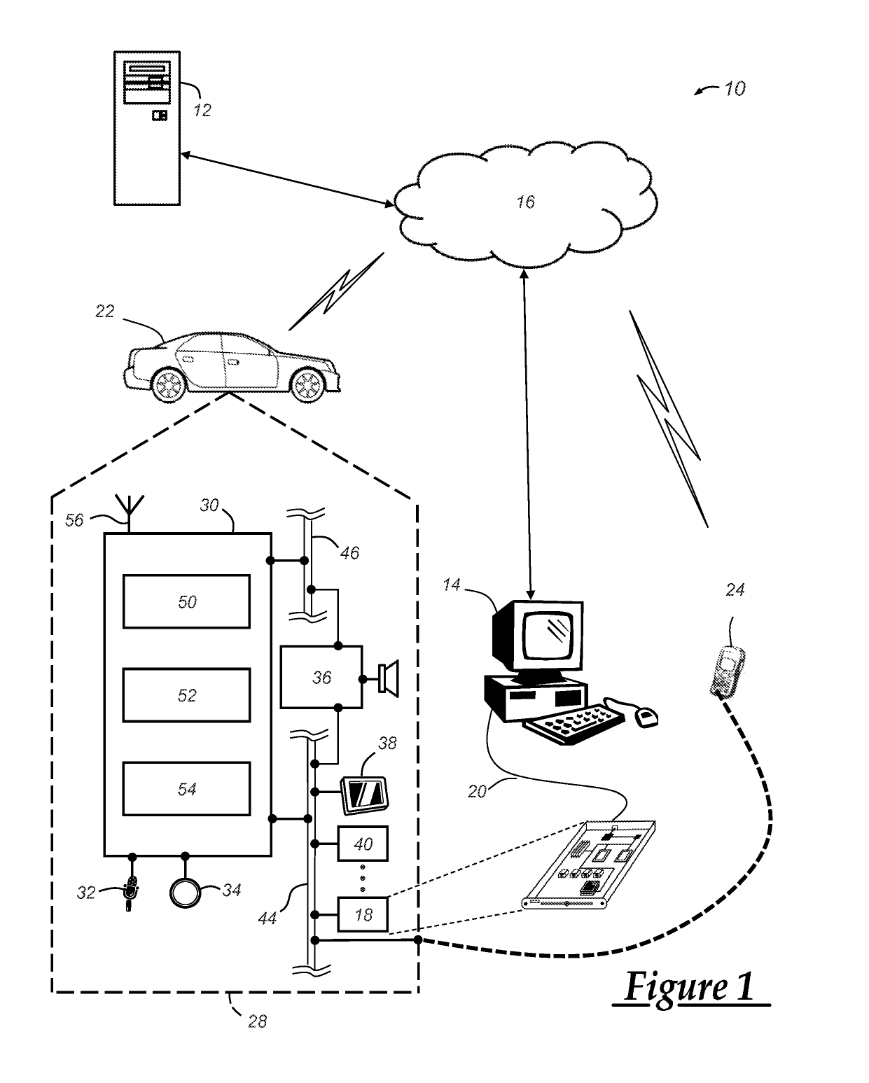

With reference to FIG. 1, there is shown a system 10 that can be used to implement the method of controlling access to electronic control units (ECUs) described below. The system 10 generally includes a central facility 12 that stores or generally has access to a master encryption key. The central facility 12 can be connected to an ECU supplier computer 14 via a communications network 16. As part of producing or programming ECUs, the supplier computer 14 can use a supplier encryption key that is created using the master encryption key. The supplier computer 14 can be communicatively linked with an ECU 18 such that the computer 14 can provide programming that includes one or more ECU unlock authorization keys and an ECU identifier to the ECU 18 via a communication link 20. Once programming is complete, the ECU 18 can be installed in a vehicle 22. After installation, an authorized user may attempt to access the ECU 18 using a device, such as a vehicle diagnostic tool 24. The authorized user can communicatively link the vehicle diagnostic tool 24 with the vehicle 22 and the vehicle diagnostic tool 24 can also wirelessly communicate with the central facility 12 as well. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such computing system 10; however, other systems not shown here could employ the disclosed method as well.

The central facility 12 can include one or more computers accessible from a remote location via the communications network 16. The central facility 12 can act as a repository for the master encryption key and accept queries from authorized users seeking to generate supplier encryption keys and/or ECU unlock authorization keys. As part of the computing resources or computers used at the central facility 12, the central facility 12 can include computer-readable memory devices that store not only the master encryption key but also one or more supplier identifiers that each uniquely identify a particular supplier or manufacturer of ECUs. It is also possible for the central facility 12 to access the master encryption key from a remote location.

The ECU supplier computer 14 can be a computing device, such as a personal computer (PC), operated by an organization that supplies/manufactures ECUs or a person who services ECUs. The supplier computer 14 generally includes hardware in the form of one or more microprocessors, memory devices, peripherals, and modems. A typical supplier computer 14 can receive input from peripherals such as a keyboard and a mouse and output information via other peripherals, such as a monitor. In this arrangement, it is common for the supplier computer 14 to remain stationary on a desktop or other similar location. However, it is also possible to implement the supplier computer 14 as a portable device having many if not all of the elements discussed above, such as a laptop or handheld computer (not shown). The microprocessors of the supplier computer 14 can include a central processing unit (CPU) that executes software or software instructions in form of computer-readable code. The software can be stored in the memory device, which can be any type of non-volatile memory as is known in the art. Communications between the CPU and other hardware elements can be carried out over a bus, as can be implemented using a printed circuit board (PCB). In one implementation, the supplier computer 14 can use the CPU to access software that creates encryption keys by seeding or entering an ECU identifier including a supplier identifier into a key generation algorithm using the supplier encryption key that is stored in the memory devices of the supplier computer 14. Encryption keys can be created using key generation algorithms that are discussed below in more detail. Furthermore, the ECU supplier computer 14 can implement different hardware and/or software solutions that help protect the secrecy of the supplier encryption keys. In some implementations the ECU supplier computer 14 can be used with a Hardware Security Module that can implement a security processor to safeguard supplier encryption keys, as is known to those skilled in the art.

Communication system 16 can include elements of a land-based communication system as well those of a wireless communication system. In one implementation, the communication system 16 comprises a cellular telephone system that includes a plurality of cell towers, one or more mobile switching centers (MSCs), as well as any other networking components required to connect the wireless communication system with a land network. Each cell tower includes sending and receiving antennas and a base station, with the base stations from different cell towers being connected to the MSC either directly or via intermediary equipment such as a base station controller. The cellular system can implement any suitable communications technology, including for example, analog technologies such as AMPS, or the newer digital technologies such as CDMA (e.g., CDMA2000), GSM/GPRS, or 4G LTE. As will be appreciated by those skilled in the art, various cell tower/base station/MSC arrangements are possible and could be used to implement the wireless capabilities of communication system 16. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

The land network portion of the communication system 16 may be a conventional land-based telecommunications network that is connected to one or more landline telephones. For example, the land network may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof.

The ECU 18 can be communicatively linked to the supplier computer 14 via a communication link 20. ECUs are devices that can include a variety of hardware elements, such as a microprocessor, one or more memory devices, input/output elements, a communications bus linking these hardware elements, and a housing that substantially surrounds the hardware. The ECU 18 can store software instructions at the ECU 18 in the microprocessor, the memory device(s), or both as well as encryption keys that can be used to regulate access to the ECU 18 or its functionality. The communication link 20 can be a wired data connection, such as a universal serial bus (USB) connection or other similar data cable protocol as is known. In one implementation, the supplier computer 14 is connected via a data cable having connectors on each end, such as universal serial bus (USB) connectors, that bi-directionally carries data between the supplier computer 14 and the ECU 18. However, in other applications, the ECU 18 could implement the communication link 20 as an antenna (not shown) that can be used to wirelessly communicate with the supplier computer 14.

Once programmed by the supplier computer 14, the ECU 18 can be installed in the vehicle 22. The vehicle 22 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 are shown generally in FIG. 1 and include a telematics unit 30, a microphone 32, one or more pushbuttons or other control inputs 34, an audio system 36, a visual display 38, and a GPS module 40. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with other telematics-enabled vehicles or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, electronic control units (ECUs), and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to a remote computer system, such as central facility 12, for other purposes, such as fleet management.

Apart from the audio system 36 and GPS module 40, the vehicle 12 can include one or more ECUs 18 in the form of electronic hardware components that are located throughout the vehicle and typically receive input from one or more sensors and use the sensed input to perform diagnostic, monitoring, control, reporting and/or other functions. Each of the ECUs 18 is preferably connected by communications bus 44 to the other VSMs, as well as to the telematics unit 30, and can be programmed to run vehicle system and subsystem diagnostic tests. As examples, one ECU 18 can be an engine control module (ECM) that controls various aspects of engine operation such as fuel ignition and ignition timing, another ECU 18 can be a powertrain control module that regulates operation of one or more components of the vehicle powertrain, and another ECU 18 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned ECUs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

A vehicle diagnostic or scan tool 24 can be communicatively linked with the vehicle 12 via bus 44 and interact with one or more ECUs 18 thereby gathering data and/or performing diagnostics tests on vehicle operations and/or problems. The vehicle diagnostic tool 24 can include On-Board Diagnostics (OBD) II tools and be implemented in a variety of ways, such as a GM Tech-2 device, a GM Multiple Diagnostics Interface (MDI), a generic SAE J2534 device, or similar device. The vehicle diagnostic tool 24 can include one or more communication ports for transmitting data via a wired or wireless connection. Or in another implementation, the vehicle diagnostic tool 24 can include wireless communication hardware that provides the tool 24 the ability of wirelessly communicate information to the central facility 12. The wireless communication can be carried out via a cellular wireless connection or via short-range wireless communication techniques, such as using a short-range wireless antenna and a Wi-Fi hotspot. For instance, the vehicle diagnostic tool 24 can include an RS232 port for communicatively linking the tool 24 via wire to an OBD II connector on the vehicle 22, which can be used to send and receive data between the tool 24 and one or more ECUs 18 via the communications bus 44. In addition, the vehicle diagnostic tool 24 can wirelessly communicate data or information between the tool 24 and the central facility 12.

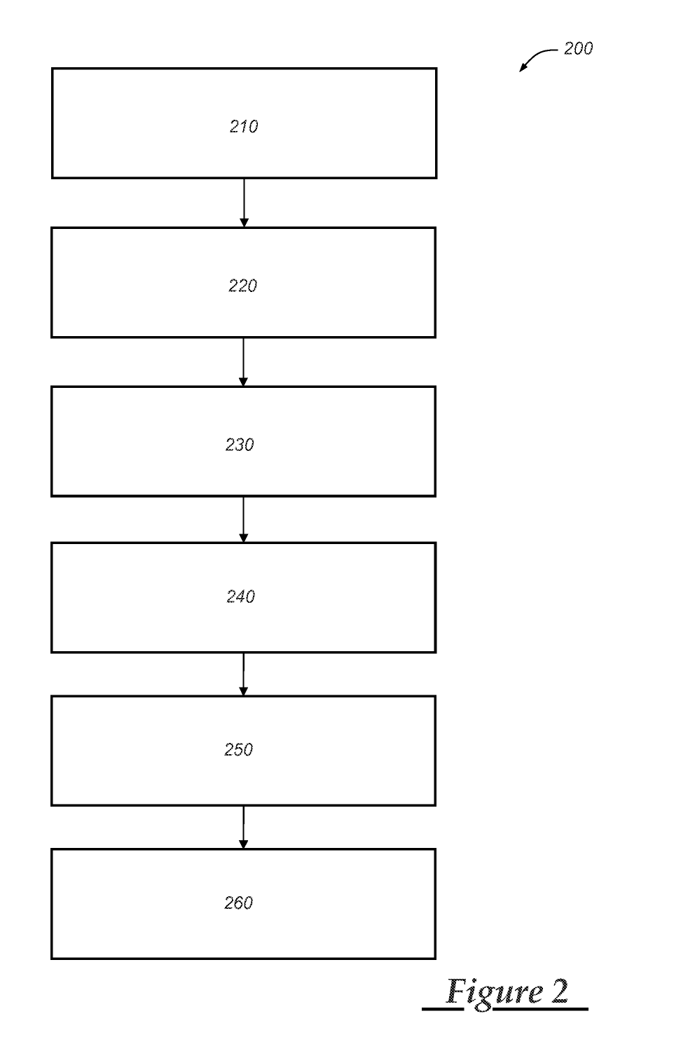

Turning now to FIG. 2, there is shown a method 200 of controlling access to electronic control units (ECUs). The method 200 begins at step 210 by generating a master encryption key for creating a supplier encryption key. The master encryption key can be generated using a variety of cryptographic techniques. For instance, the processor of a computer can input data into a key derivation function or key generation algorithm and then generate the master encryption key as a result. In one example of this, a pseudo-random function or a cryptographic hash function can receive entropy data as input and then output a master encryption key of a specified bit length. The entropy data can be generated using a pseudo-random number generator that can be located at the central facility 12. One possible implementation of the master encryption key can have a length of 128 bits. Alternatively, the master encryption key could have a bit length much greater than 128 bits given that the master encryption key may be stored centrally as a secret encryption key. The method 200 proceeds to step 220.

At step 220, the supplier encryption key is derived using the master encryption key and a supplier identifier. A unique supplier identifier can be created for each supplier or manufacturer of ECUs. Then, a supplier encryption key can be created for each supplier/manufacturer of ECUs that is based on a cryptographic manipulation of the supplier identifier assigned to the supplier or manufacturer that receives the supplier encryption key. The terms “supplier” and “manufacturer” may be used interchangeably herein and both can be interpreted as referring to an organization that manufactures or sells an ECU. The central facility 12 can identify a plurality of ECU suppliers that provide ECUs for installation in vehicles. For each ECU supplier, the central facility 12 can attribute or assign a value that can represent the supplier identifier. The value can be a random or sequential string of digits that are used to identify a particular ECU supplier. After assigning each ECU supplier its own supplier identifier, a key generation algorithm can use the master encryption key and the supplier identifier to generate a unique supplier encryption key for each supplier. The supplier encryption key can then be provided to the ECU supplier computer 14 via communication network 16. The method 200 proceeds to step 230.

At step 230, an ECU identifier is issued that uniquely identifies an ECU 18 and includes the supplier identifier. During the process of manufacturing ECUs, the ECU supplier can identify each ECU using a unique ECU identifier. As assembly or manufacturing proceeds, each ECU that is produced by a particular ECU supplier can be differentiated from other ECUs that supplier produces using the ECU identifier. The ECU identifier can be stored in a memory portion of the ECU associated with that identifier. It is possible that the ECU identifier can be a serial number associated with the ECU 18 at the time that the ECU 18 is manufactured. However, a portion of each ECU identifier issued or assigned by a particular ECU supplier can include the supplier identifier of the supplier that manufactured the ECU as is discussed above with respect to step 220. In that sense, each ECU identifier is unique but shares a common supplier identifier that indicates the identity of the ECU supplier that made the ECU. Step 230 can be implemented using the supplier computer 14 above or other similar computer resources. The method 200 proceeds to step 240.

At step 240, an ECU unlock authorization key is generated for the ECU 18 using the supplier encryption key and the ECU identifier. Once an ECU supplier has assigned an ECU identifier to an ECU, such as ECU 18, the ECU supplier can use the supplier encryption key and the ECU identifier with a key generation algorithm to create an ECU unlock authorization key using the supplier computer 14. The ECU unlock authorization key can then be stored in the memory portion of the ECU 18 along with its ECU identifier. In another implementation, a second ECU unlock authorization key can be created as well using the supplier computer 14. ECUs can be encoded with multiple unlock authorization keys in order to provide different levels of access to an ECU. When two or more authorization keys are to be stored at the ECU 18, a key generation algorithm can use the ECU identifier and the supplier key to output a first ECU unlock authorization key as well as a second unlock authorization key. The supplier computer 14 can then program the ECU 18 so that different levels of access are given for the first ECU unlock authorization key and the second ECU unlock authorization key. Both the first and second ECU unlock authorization keys can then be stored in the ECU 18. After the ECU 18 has been programmed such that its ECU identifier and at least one ECU unlock authorization key are stored at the ECU 18, the ECU 18 can then be installed in the vehicle 22. The method 200 proceeds to step 250.

At step 250, an ECU identifier that has been accessed from the ECU 18 is received at the central facility 12 having access to the master encryption key. After the ECU 18 has been installed in the vehicle 22, an authorized person, such as a person employed by a vehicle dealership service department, may want to access the ECU 18 for a number of reasons; diagnostic service or providing software updates are two examples of these reasons. The authorized person can access the ECU 18 of the vehicle 22 by attaching the vehicle diagnostic tool 24 to an OBD II connector of the vehicle 22 and obtaining the ECU identifier of the ECU 18. In addition to the ECU identifier, the vehicle diagnostic tool 24 can also obtain a random value or “challenge” that is generated by the ECU 18. The vehicle diagnostic tool 24 can then transmit the ECU identifier as well as the challenge to the central facility 12. While FIG. 1 depicts the vehicle diagnostic tool 24 wirelessly transmitting the ECU identifier and the challenge to the central facility 12 via the communication network 16, it should be appreciated that the communication path between the ECU 18 located in the vehicle 22 and the central facility 12 can be established in a variety of ways that may or may not include the vehicle diagnostic tool 24. Furthermore, it is possible to determine whether or not a person is authorized to access ECUs using different techniques. For instance, a person can be deemed authorized only if they have a subscription service provided by the central facility 12, such as a telematics subscription service. Or in another example, a person can be authorized by a password or passcode that is ultimately provided to the central facility 12. Other implementations will be apparent to those skilled in the art.

Once the central facility 12 receives the ECU identifier of ECU 18 and the challenge, the central facility 12 can read the ECU identifier and isolate from it the supplier identifier included in the ECU identifier. The central facility then can know the identity of the ECU supplier that manufactured the ECU. The method 200 proceeds to step 260.

At step 260, the supplier encryption key is re-created from the supplier identifier using the master encryption key and the ECU unlock authorization key is generated using the supplier encryption key and the ECU identifier. Once the central facility 12 identifies the supplier of the ECU 18, the facility 12 can initiate a key generation algorithm that uses the supplier identifier and the master encryption key to re-create the supplier encryption key. Then, using the ECU identifier of ECU 18, the central facility 12 can input the ECU identifier into a key generation algorithm using the supplier encryption key to re-create the ECU unlock authorization key that is stored in the ECU 18. Using the re-created ECU unlock authorization key, the central facility 12 can enter the random value or challenge it received into a key generation algorithm along with the re-created ECU unlock authorization key and generate a unique value to be sent to the authorized person that will be referred to herein as a challenge response. The central facility 12 can then communicate the challenge response to the authorized person (in this implementation, via the vehicle diagnostic tool 24), who can then use the challenge response to gain access to the ECU 18. The vehicle diagnostic tool 24 can communicate the challenge response to the ECU 18. The ECU 18 can enter the challenge into the unlock encryption key stored in the memory portion of the ECU 18. If the output from the stored encryption key is the same as the challenge response, the authorized person can access functional aspects of the ECU 18; otherwise, the person may be denied access to the ECU 18. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of controlling access to electronic control units (ECUs), comprising the steps of:
(a) receiving, at an ECU supplier computer, a supplier encryption key derived from a master encryption key using a supplier identifier that identifies an ECU supplier;
(b) issuing an ECU identifier that identifies an ECU and includes the supplier identifier;
(c) generating for the ECU an ECU unlock authorization key using the supplier encryption key and the ECU identifier; and
(d) storing the ECU unlock authorization key and the ECU identifier in the ECU.

2. The method of claim 1, further comprising the step of generating a plurality of ECU unlock authorization keys using the supplier encryption key and the ECU identifier, wherein each ECU unlock authorization key provides a different amount of access to the ECU.

3. The method of claim 1, wherein the supplier encryption key is communicated from a central facility having access to the master encryption key.

4. The method of claim 1, further comprising the step of assigning the supplier identifier to the ECU supplier at a central facility.

5. The method of claim 1, further comprising the step of installing the ECU in a vehicle.

6. The method of claim 1, further comprising the steps of accessing the ECU identifier from the ECU, identifying the supplier identifier from the ECU identifier, inputting the supplier identifier into a key generation algorithm using the master encryption key, and re-creating the supplier encryption key.

7. The method of claim 6, further comprising the step of inputting the ECU identifier into a key generation algorithm using the supplier encryption key and re-creating the ECU unlock authorization key.

8. A method of controlling access to electronic control units (ECUs), comprising the steps of:
(a) receiving at a central facility having access to a master encryption key an ECU identifier that has been accessed from an ECU;
(b) isolating a supplier identifier included in the ECU identifier;
(c) re-creating a supplier encryption key from the supplier identifier using the master encryption key; and
(d) generating an ECU unlock authorization key using the supplier encryption key and the ECU identifier.

9. The method of claim 8, further comprising the step of generating a second ECU unlock authorization key using the supplier encryption key and the ECU identifier, wherein each ECU unlock authorization key provides a different amount of access to the ECU.

10. The method of claim 8, wherein the ECU identifier is communicated from a vehicle diagnostic tool.

11. The method of claim 8, wherein the ECU is installed in a vehicle.

12. A method of controlling access to electronic control units (ECUs), comprising the steps of:
(a) generating a master encryption key for creating supplier encryption keys;
(b) generating a supplier encryption key using the master encryption key and a supplier identifier;
(c) providing the supplier encryption key to an ECU supplier computer;
(d) issuing an ECU identifier that uniquely identifies an ECU and includes the supplier identifier;
(e) generating for the ECU an ECU unlock authorization key using the supplier encryption key and the ECU identifier;
(f) storing the ECU unlock authorization key and the ECU identifier in the ECU;
(g) receiving, at a central facility having access to the master encryption key, the ECU identifier that has been accessed from the ECU;
(h) isolating the supplier identifier included in the ECU identifier;
(i) recreating the supplier encryption key from the supplier identifier using the master encryption key; and
(j) generating the ECU unlock authorization key using the supplier encryption key and the ECU identifier.

13. The method of claim 12, further comprising the step of generating a plurality of ECU unlock authorization keys using the supplier encryption key and the ECU identifier, wherein each ECU unlock authorization key provides a different amount of access to the ECU.

14. The method of claim 12, further comprising the step of assigning the supplier identifier to the ECU supplier at a central facility.

15. The method of claim 12, further comprising the step of installing the ECU in a vehicle.
